(19) United States
(12) Patent Application Publication
(10) Pub. No.: US 2008/0277055 A1
(43) Pub. Date: Nov. 13, 2008

(54) Manufacturing Process of a Composite Bamboo Board

(75) Inventors: Bin Yang, Sichuan (CN); Zaichang Zhang, Sichuan (CN); Yingfeng Pan, Sichuan (CN)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Sichuan Shengda Forestry Industry (Group) Co., L.,, Chengdu City (CN)

(21) Appl. No.: 11/996,676

(22) PCT Filed: Sep. 20, 2006
(86) PCT No.: PCT/CN06/02454

§ 371 Date: Jun. 16, 2008

(30) Foreign Application Priority Data
Sep. 26, 2005 (CN) 200510021733.4

(51) Int. Cl. B32B 37/00

(52) U.S. Cl. 156/272.2

(57) ABSTRACT

Manufacturing process of a composite bamboo board, comprising assembling and hot-pressing adhesive-coated bamboo fiber bundles, wherein the said adhesive is a composition comprising of adhesive base material, coupling agent and impregnating wetting agent, the said adhesive base material is one or more selected from a group consisting of urea-formaldehyde resin, melamine, phenolic resin, and water based isocyanate; the said coupling agent is agent which can couple the interfaces of bamboo fiber bundles and the adhesive base material; the impregnating wetting agent is one or more surfactant; and the said hot-pressing includes heating by using high-frequency electromagnetic field with frequency being of 1 KHz or higher and compressing the adhesive-coated bamboo fiber bundles.

### FIELD OF THE INVENTION

The present invention relates to manufacturing process of a composite bamboo board.

### BACKGROUND OF THE INVENTION

Bamboo is a kind of natural biomaterials, and it has advantages of abundance in source and low cost because it grows fast and easy to plant. As the source of wood is becoming scarce, bamboo materials are more and more used to replace wood materials. The bamboo board produced by bamboo materials has high surface hardness, good tactility, good wear resistance, handsome grain, light and elegant colors, and gives people a feeling of returning to nature, therefore is highly welcomed. Currently, bamboo board, which is widely used in constructions, vehicles, packing, decorations, manufactures, and the like, includes woven mat plybamboo, woven mat and curtain plybamboo, bamboo plywood, bamboo strip laminated board, bamboo floor board, and the like.

Because the utilization rate of bamboo in traditional processing process is low (no higher than 35%), leaving large amount of remainders and small-size bamboo un-fully-utilized, which results in a waste of source, high cost of manufacturing bamboo board and lack of competitive power. Meanwhile, the strength of the bamboo materials is reduced because the raw material is processed by cutting such as sawing open and splitting. What is more, the current bamboo board also has drawbacks such as large amount of adhesive, complex processing, too much manual operation, and difficulty of quality control. Therefore, re-combined bamboo emerged.

For example, Chinese Patent Publication No. 118929C discloses a process for producing re-combined bamboo board, including: truncating, grinding, drying, coating adhesive, second time drying, assembling and hot-pressing of small-size bamboo whose diameter is less than 80 mm, wherein the said grinding includes peeling off the green outer skin of the bamboo, subdividing and then grinding the resultant into bamboo fibers bundles in which the bamboo fibers are connected transversely, lose and interlinked longitudinally, and have not been disordered, wherein subdivision includes splitting the bamboo whose green outer skin has been peeled off into two pieces by a bamboo splitting machine. The said adhesive is phenolic resin or urea-formaldehyde resin. The said hot-pressing is hot-in and hot-out process, and when the adhesive is phenolic resin, the conditions of hot-pressing includes, the pressure is 3 MPa, the temperature is 140° C., the time is 1 min per every millimeter of the thickness of the board, and the board is loaded and unloaded at 80° C. The process could effectively increase the utilization rate of bamboo materials to 90% or higher.

Chinese Patent Publication No. 1616200A also discloses a process for processing re-combined bamboo board, including: (1) preparing bamboo fiber bundles, which includes cutting bamboo materials into bamboo knots at a certain length, splitting the big bamboo knots whose diameters are more than the preset value into two pieces, flattening the bamboo knots and processing into bamboo splints whose radial thickness is in a certain range, thread rolling the bamboo splints into bamboo filaments in the tangential direction, to produce bamboo fiber bundles which are at the same thickness; (2) soaking, which includes soaking the bamboo fiber bundles into sulfuric acid solution whose concentration is 0.5-2.0% under the temperature from 60 to 90° C. for 1.5-2.5 hours; (3) drying under the temperature from 80 to 120° C. to produce bamboo fiber bundles whose content of water is 6-12%; (4) coating adhesive, which includes dipping the bamboo fiber bundles in adhesive to coat adhesive for 50-80 seconds; (5) second time drying, which includes drying the adhesive-coated bamboo fiber bundles under the temperature of 60-80° C. to produce bamboo fiber bundles whose content of water is 8-13%; (6) hot-pressing, which includes feeding the dried bamboo fiber bundles into hot-pressing machine at the temperature of 110-140° C. to press by upper pressing and two-side pressing for 15-25 seconds/mm, wherein the upper pressure is 5 MPa/cm³ and the side pressure is 4 MPa/cm³.

Because instead of using traditional process for peeling off the green outer skin of the bamboo and manually assembling, this process uses the producing process of “hot-in and hot-out”, the time for hot-pressing is highly reduced, therefore thermal energy is saved and efficiency is increased. Meanwhile, by using upper-pressing a two-side pressing at the direction of the grains, the products do not have any crack both inside and outside and are highly even.

However, because the above said processs need to grind the raw bamboo materials parallel to grain direction to produce bamboo fiber bundles, and then re-combine the bamboo fiber bundles by conglutinating them together by using adhesive such as phenolic resin, which result in a great reduce of the strength in the transverse to grain direction, as the strength in this direction is much lower than the raw bamboo materials as well as the strength parallel to grain direction. Although this reduce could be compensated by using multi-layers of bamboo fiber bundles interlaced at both transverse and longitudinal directions, this compensation is not an effective solution of this problem, as the strength between the bamboo fibers in a bamboo fiber bundle and the strength between the bamboo fiber bundles which are set alongside are still not good. What is more, the bamboo boards produced according to the above mentioned processs are easy to deform in the parallel to grain direction; and in the using process, the environment conditions such as the temperature and the change of humidity will make the bamboo materials to absorb water and dehydrate alternately, and the difference between the deformation of different assembled bamboo fiber bundle layers will result in the warpage deformation. Furthermore, when thick bamboo boards are needed to be produced, the heating time needed is relatively long, which will easily result in uneven heat, and surface bamboo is carbonized while the adhesive inside of the bamboo materials is still not solidified. Normally using the heat conduction relies on the heat transfer rate of the composition of the products; however, high speed of heat transfer is difficult to perform when it comes to non-metal materials comprising of bamboo material and adhesive.

### SUMMARY OF THE INVENTION

One purpose of this invention is to overcome the problem that the bamboo board produced according to the prior processes has low strength in the transverse to grain direction, and to provide manufacturing process of a composite bamboo board which has high strength in both transverse to grain direction and parallel to grain direction.

The manufacturing process of a composite bamboo board provided by this invention includes assembling and hot-pressing of adhesive-coated bamboo fiber bundles, wherein, the said adhesive is a composition comprising of adhesive base material, coupling agent and impregnating wetting agent, wherein the said adhesive base material is one or more selected from a group consisting of urea-formaldehyde resin, melamine, phenolic resin, and water based isocyanate; the said coupling agent is agent which can couple the interfaces of bamboo fiber bundles and the adhesive base material; the impregnating wetting agent is one or more surfactant; and the said hot-pressing includes heating by using 1 KHz or higher high-frequency electromagnetic field and compressing the adhesive-coated bamboo fiber bundles.

One aspect of this invention is to improve the adhesive, and another aspect of this invention is to improve the hot-pressing process. By combining these two aspects together, the strength of the bamboo board in the transverse direction produced according to the process provide in this invention is increased nearly close to the strength in parallel to grain direction. For example, both the MOR transverse to grain and the MOR parallel to grain of the bamboo board produced in Example 1 are up to 170 MPa and higher according to GB/T 17657-1999, and the two strengths are almost equal; and the tension transverse to grain and tension parallel to grain of the bamboo boards produced in the Examples are almost equal, which mean that the properties of the bamboo board in each direction are consistent. Furthermore, by using hot-pressing under high-frequency hot-pressing conditions, the inside of bamboo board is evenly heated, therefore the water content of the bamboo board is even, which can prevent the bamboo board from deform under severe environment. By using the process provided by this invention, the temperature both inside and outside of the bamboo board can increase simultaneously to make the adhesive solidify simultaneously, therefore the bamboo board thus produced has advantages such as no wildewing, no insect, high density, high strength, water proof, moisture proof, little deformation. Besides, the operational device used in this hot-pressing process is simple, easy to control the temperature and has little thermal inertia, therefore it can increase and decrease temperature rapidly, is suitable for forming large scale and thick products, and it also can shorten the producing period greatly.

### BRIEF DESCRIPTION OF THE DRAWINGS

FIG. 1 is the structure scheme of the preferable high-frequency hot press used in this invention.

FIG. 2 is the structure scheme of the hydraulic die 2 of the hot press as show in FIG. 1.

### DETAILED DESCRIPTION OF THE PREFERRED EMBODIMENTS

According to the present invention, although that using 1000 Hz (i.e. 1 KHz) or higher high-frequency electromagnetic field could achieve the purpose of this invention, preferably, the said high-frequency electromagnetic field is from 1 KHz to 6 GHz, and more preferably is from 1 MHz to 2.5 GHz, and even more preferably is from 1 MHz to 25 MHz. The heating time is preferably to ensure that the adhesive-coated bamboo fiber bundles are under the temperature from 50 to 210° C., and more preferably is from 90 to 120° C.

The high-frequency hot press is commercially available, and it also could be produced in various processes. High-frequency hot press is a combined device of high-frequency media heating and hydraulic die, including a high-frequency magnetic field generator, and a hydraulic die adapted for it. The principle of high-frequency hot-pressing is to polarize the polar molecules inside the substance repeatedly by using high-frequency electromagnetic field, causing rapid movements of the molecules under the effect of high frequency alternating electromagnetic field and to generate frictional heat to increase the temperature, therefore to achieve the purposes of making the re-combined bamboo board thicken, quickly be formed by heating, and industrial large scale produce.

During the process of high-frequency heating, the media absorbs electric energy and its ability to generate heat is not relevant to its heat conductivity, but is proportional to the factors such as media loss factor, the square of electric field intensity and the electric field frequency. The media loss factor represents the difficulty of the media to be heated by high-frequency. The bigger the loss factor is, the better the effect of high-frequency heating is. In the said adhesive-coated bamboo fiber bundles in the present invention, because the said adhesive is a composition comprising of adhesive base material, coupling agent and impregnating wetting agent, its loss factor is much bigger than the factor of bamboo fibers. So that during the process of high-frequency heating, the adhesive is heated faster than the bamboo fibers, therefore to ensure that the bamboo fibers will not be damaged when the adhesive is solidified. Furthermore, because the high-frequency electromagnetic field only has effect on polar molecules, and in the present invention, the polarity of water is much bigger than other substance, so that the high-frequency heat could heat water molecules selectively without any damage to the structure of the said adhesive-coated bamboo fiber bundles.

In more details, comparing to traditional hot-pressing using convective heating, the present invention which uses high-frequency heating, has the following advantages of:

(1) fast heating speed, and being able to generate heat instantly, achieving rapid heating in a very short time, to evaporate the water and to solidify the adhesive layer;

(2) even heating, able to heat every part at the same time and increase the temperature evenly;

(3) good quality of the heated products, and low waste rate because of even heating and small deformation of workpieces;

(4) selective heating, able to heat selectively to the media which has a big loss factor, therefore to utilize energy economically and reasonably, the energy loss small and heat efficiency high;

(5) easy to control the heating process, by electrifying and deenergizing to control and adjust temperature accurately, therefore to achieve automatic, linkage and flow production;

(6) good heating environment and low labour intensity;

(7) small occupied area of the device and easy to operate; and,

(8) because of the sterilization function of high-frequency electromagnetic field, the bacteria being killed in the process of hot-pressing, which is good for the antiseptic long term preserve and use of bamboo board.

In order to further improve the properties of bamboo board and the compactness of the product, according to the present invention, the pressure of the hot-pressing is preferably 10-60 MPa, more preferably 20-55 MPa. The time of hot-pressing varies according to the thickness of the bamboo board to be produced, and it can be any time which is enough to form the bamboo fiber bundles into board shape and solidify the adhesive. For example, when producing 5-200 mm thick bamboo board, the time of hot-pressing is preferably 0.5-10 min.

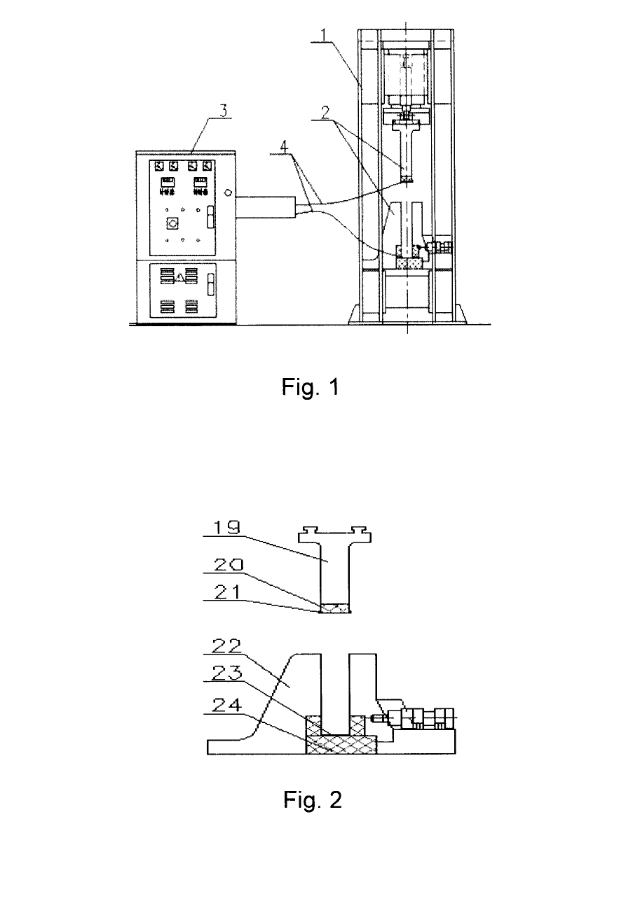

In the present invention, the said high-frequency hot press preferably has the structure shown in FIG. 1, including a hydraulic press 1, a high-frequency magnetic field generator 3, and a hydraulic die 2, wherein the hydraulic press 1 is electrically connected with the high-frequency magnetic field generator 3 by transmission line 4 which can transmit electromagnetic field. The hydraulic die 2 is fixed on the hydraulic press 1, wherein the hydraulic die 2 is electrically connected with the high-frequency magnetic field generator 3.

The structure of the hydraulic die 2 as shown in FIGS. 2-3, includes a punch 19, a punch insulating plate 20, a punch electrode plate 21, a female die fixed end 22, a female die electrode plate 23, and a female die insulating plate 24. The punch 19 is connected with a upper backing plate (not indicated) of the hydraulic press 1, and the female die insulating plate 24 is connected with the lower backing plate (not indicated) of the hydraulic press 1 while fixed on the hydraulic press 1 by the female die fixed end 22. The high-frequency magnetic field generator 3 is connected with the punch electrode plate 21 and the female die electrode plate 23 by two transmission lines 4 which can transmit electromagnetic field. The said transmission lines 4 which can transmit electromagnetic field transmit the electromagnetic field generated by the high-frequency magnetic field generator 3 to the punch electrode plate 21 and the female die electrode plate 23 which are on the hydraulic die 2. The said transmission lines 4 which can transmit electromagnetic field are known by the persons skilled in the art, for example, it could be metallic foil strap regularly used in this area, such as copper foil strap and/or aluminum foil strap. The punch 19 is fixed with the punch electrode plate 21 by the punch insulating plate 20. The female die fixed end 22 is fixed with the female die electrode plate 23 by the female die insulating plate 24. Both the punch 19 and the female die fixed end 22 are made of high-strength materials such as steel, while the punch insulating plate 20 and the female die insulating plate 24 are made of insulating materials, therefore to insulate the hydraulic press with high-frequency electromagnetic field to ensure the security of the operators as well as to ensure the high-frequency electromagnetic only heat the bamboo fiber bundles which are coated with adhesive, increasing the utilization rate of the high-frequency electromagnetic field. The punch electrode plate 21 and the female die electrode plate 23 are made of conductive materials such as copper, aluminum, therefore to electrically connect the hydraulic die 2 and the high-frequency magnetic field generator 3.

The high-frequency hot press only adds a hydraulic die 2 on the base of regular high-frequency hot press, while all the other parts and connection are the same as regular high-frequency hot press. For example, the hydraulic press 1 includes main hydraulic cylinder, lifting cylinder, upper backing plate, frame bearing beam, electromagnetic shielding device, lower backing plate of hydraulic press and high hydraulic station. The hydraulic press 1 and high-frequency magnetic field generator 3 can be every kind of hydraulic presses and high-frequency magnetic field generators used in high-frequency hot press, and are available commercially. The hydraulic press 1 is connected with the high-frequency magnetic field generator 3 by the hydraulic die 2.

The operation process of the said high-frequency hydraulic press is the same as the operation process of regular high-frequency hydraulic press, and the operations of assembling and hot-pressing of the adhesive-coated bamboo fiber bundles when operated on the said high-frequency hydraulic press are also almost the same as operations when operated on regular high-frequency hydraulic press, including assembling of the adhesive-coated bamboo fiber bundles on the female die insulating plate 24, then closing the punch 19 and the female die fixed end 22 by hydraulic press 1, pressing and heating to form bamboo board. Preferably, the high-frequency hydraulic press can include a control console, to automatically control the operation of hydraulic press and high-frequency magnetic field generator to realize automatic operation. The structure of the control console, and the connection relations between the hydraulic press 1 and the high-frequency magnetic field generator 3 are known by the persons skilled in the art.

Besides the advantages of fast heating speed, and able to generate heat instantly, achieving rapid heating in a very short time, to evaporate the water and to solidify the adhesive layer, by using the punch and female die together, the said high-frequency hot press on one hand can provide relatively high front pressure and side pressure, therefore to further improve the mechanical properties of the bamboo board, on the other hand, it have heat evenly, able to heat every part at the same time and increase the temperature evenly. Furthermore, the quality of the heated products is good, and the waste rate is low because of even heating and small deformation of workpieces. The heating process is easy to control, by electrifying and deenergizing to control and adjust temperature accurately, therefore is useful to achieve automatic, linkage and flow production.

The process provided by the present invention is suitable for forming and producing re-combined flat type board, re-combined non-conventional bamboo board and wood composite artificial board. This process is also suitable for composite polymer materials modified by wood and bamboo, especially economic and high efficient for producing thick products. The thickness of the board could be 5-500 mm according to demand.

The said bamboo fiber bundles could be bamboo fiber bundles produced in any process. For example, it could be produced according to the process disclosed in CN 1189292C, truncating the raw bamboo materials, peeling off the green outer skin of the bamboo, grinding into bamboo fibers bundles in which the bamboo fibers are connected transversely, lose and interlinked longitudinally, coating adhesive onto the bamboo fiber bundles to produce adhesive-coated bamboo fiber bundles. The said raw bamboo materials could be any kind of bamboo materials, for example, bamboo surplus material after processing of any diameter and length, and the mass source of small-size sundry bamboo (such as neosinocalamus affinis and whangee) which are not reasonably utilized yet. In the present invention, the diameter of the bamboo fibers in the bamboo fiber bundles is preferably 0.001-3 mm, more preferably 0.01-1 mm.

The said adhesive is a composition comprising of adhesive base material, coupling agent and impregnating wetting agent.

The said adhesive base material is one or more selected from a group consisting of urea-formaldehyde resin, melamine, phenolic resin, and water based isocyanate.

The said coupling agent can be any agent which can couple the interfaces of bamboo fiber bundles and the adhesive base material, for example, the coupling agent can be one or more selected from a group consisting of silane coupling agents (such as KH-560, KH-570 and KH-590), titanate coupling agents (NDZ-311), aluminate coupling agent such as JX-2 type aluminate coupling agent and AX-3 type aluminate coupling agent.

The impregnating wetting agent is one or more surfactant, for example, nonylphenol ethoxylates (such as one or more selected from OP-3, OP-7, OP-10 and TX-10) and one or more selected from fatty alcohol-polyoxyethylene ether (peregal) series surfactant.

The content of adhesive base material is preferably 90-99.9 wt %, more preferably 96-99.8 wt %; the coupling agent is preferably 0.05-5 wt %, more preferably 0.1-2 wt %; and the impregnating wetting agent is preferably 0.05-5 wt %, more preferably 0.1-2 wt %, to the total weight of the composition.

Preferably, the adhesive used in the present invention also contains various of other additives, for example, wherein the said additives can be one or more selected from reinforcing agent, formaldehyde adsorbent, flame retardant and antistatic agent. The additives are known by the persons skilled in the art and are available commercially.

Examples of the said reinforcing agents, which are used for further improving the strength of the bamboo board, includes inorganic fillers, such as one or more selected from light calcium carbonate, heavy calcium carbonate, talc powder, starch, and melamine resin.

The example of the said formaldehyde adsorbent is preferably urea, which is cheap, easy to obtain and good in formaldehyde capture.

The flame retardant could be halogen flame retardant, phosphorus-based flame retardant, and aluminum oxide flame retardant.

The antistatic agent is available commercially.

Preferably the amount of all the above mentioned additives is respectively 0-5 wt % to the total weight of the adhesive composition, more preferably 0.5-1.5 wt %.

The process to coat said adhesive could be spraying the adhesive solution onto the bamboo materials, or dipping the bamboo materials in the adhesive solution. The degree of coating is to ensure that the content of adhesive in the bamboo fiber bundle layers is 3-20 wt %, preferably 6-16 wt % (dry weight). In the said adhesive solution, the total weight of the adhesive composition to the weight of the solvent is preferably 1:2-3:1, calculated by the dry weight of the composition.

The inventor of this invention found that, by applying high-frequency hot-pressing to the adhesive-coated bamboo fiber bundles whose water content is 4-16 we %, the produced bamboo board has better surface strength and is more even; furthermore, the time for hot-pressing is also shortened to several seconds or tens of seconds.

Therefore, preferably, the process provided by the present invention also includes drying the bamboo fiber bundles before and after assembling. The said drying could be one or more ways selected from regular air-blast drying, vacuum drying, natural drying, and infrared drying; and it also could be one or more selected from high frequency drying, microwave drying, and light wave drying. The inventor of this invention found that using microwave drying, infrared drying or light wave drying to dry is good for the adhesive to form even solidified layer in the bamboo fiber bundles. Therefore, microwave drying, radio frequency drying or light wave drying is preferred in the present invention. The drying temperature is preferably 40-160° C., more preferably 40-105° C. The drying time is preferably to reduce the water content in the bamboo fiber bundle layer to 4-16 wt %, generally varying according to the thickness of the fiber layer and the drying temperature.

The process of the said assembling of the bamboo fiber bundles is known by the persons skilled in the art. It could be selected according to the structure of the bamboo board, for example, as disclosed in CN 1189292C, arranging the bamboo fiber layer and bamboo mat into five-layer-board billet, the big end and small end of the bamboo fiber bundle layer interleaving arranged, the outer bamboo fiber bundle layer longitudinal placed, green side facing outside; the middle layer of bamboo fiber bundle transversely placed, green side and yellow side interleaving arranged; the surface layer and bottom layer are bamboo mats. Furthermore, multiple bamboo fiber bundle layers could be overlaid directly, wherein each of the middle layer may contain a layer of bamboo fiber bundles, or it may also contain several bamboo fiber bundle layers spread and spliced together. Preferably, the upper and lower outer layers are made of a single bamboo fiber bundle layer which is big enough, therefore the produced bamboo board is beautiful and strong with the other conditions being the same.

Because high-frequency hot-pressing heating process used in the present invention is to heat from inside to outside, for the thick bamboo board such as 50 mm thick or more, the bamboo board produced after hot-pressing has a higher temperature inside than outside. In order to balance the inside temperature and outside temperature fast, preferably the process provided by this invention includes steaming the bamboo board produced after hot-pressing to adjust moisture of the same after the hot-pressing of the bamboo board. The conditions and operations of steaming to adjust moisture are known by the persons skilled in the art.

Further preferably, the process provided by the present invention also includes conserving the products after hot-pressing or steaming to adjust moisture. The conditions and operations of the said life-care is known by the persons skilled in the art, such as natural life-care under natural ventilation, or steaming the bamboo board to adjust moisture in dry kiln after hot-pressing, and then life-caring under natural environment. The conditions of natural life-care are preferably under the moisture of 20-50%RH, and the temperature is room temperature or lower than 100° C. under ventilation environment.

The detailed description will be given below with reference to the examples.

### EXAMPLE 1

This example is to illuminate the manufacturing process of a composite bamboo board according to this invention.

Add 950 g urea-formaldehyde resin powder, 10 g silane coupling agent KH-560, 10 g OP-10 (produced by Shenzhen Jintenglong Shiye Corporation), 12 g solidifying agent ammonium chloride, 10 g light calcium carbonate, and 10 g urea into 2000 mL water, and then uniformly mix to produce adhesive solution.

Use 1200 mm long whangees, longitudinally cut it into two pieces and peel off the green and yellow outer covering of the bamboo to make them uniform in color. Then use roller press to grind the whangee into loose reticulate bamboo fiber bundles whose diameters are 0.01-0.1 mm, wherein the bamboo fibers not totally detached, therefore to form bamboo fiber bundles connected with others. Dry the bamboo fiber bundles under 60° C. for 8 hours, then dip them in the above said adhesive solution for 2 min. Remove and dry to produce bamboo fiber bundles whose adhesive content is 6 wt % and water content is 6 wt %. Transversely spread the produced bamboo fiber bundles on the female die insulating plate 24 of the high-frequency hot press as shown in FIG. 1 at a thickness of 20 mm, to produce lower bamboo fiber bundle layer, then longitudinally spread the above said bamboo fiber bundles on top of it at a thickness of 30 mm to produce upper fiber layer. Rapidly close the punch 19 of the high-frequency hot press until it touches the upper fiber layer, then increase the pressure to 25 MPa, and at the same time heat at the frequency of 12.5 MHz, the temperature reaches 105° C. after 10 seconds, keep the said pressure and temperature for 1.5 min, to produce the bamboo board which is 50 mm thick. Steam the bamboo board to adjust moisture in a drying kiln for 2 hours and then keep it under 40° C. in ventilation environment until the water content is 8 wt %.

### EXAMPLE 2

This example is to illuminate the manufacturing process of a composite bamboo board according to this invention.

Add 965 g urea-formaldehyde resin, 10 g silane coupling agent KH-570, 2 g peregal A-20, 15 g solidifying agent ammonium chloride, 5 g melamine, and 3 g urea into 2000 mL water, uniformly mix to produce adhesive solution.

Use 2000 mm long moso-bamboo pieces, longitudinally cut it into two pieces and peel off the green and yellow outer covering of the bamboo to make them uniform in color. Then use roller press to grind the moso-bamboo pieces into loose reticulate bamboo fiber bundles whose diameters are 0.001-0.01 mm, wherein the bamboo fibers not totally detached, therefore to form bamboo fiber bundles connected with others. Dry the bamboo fiber bundles under 80° C. for 40 min in a infrared dryer, then dip them in the above said adhesive solution for 0.5 min. Remove and dry to produce bamboo fiber bundles whose adhesive content is 16 wt % and water content is 10 wt %. Transversely spread the produced bamboo fiber bundles whose water content is 10 wt % on the female die insulating plate 24 of the high-frequency hot press as shown in FIG. 1 at a thickness of 160 mm, to produce lower bamboo fiber bundle layer, then longitudinally spread the above said bamboo fiber bundles on top of it at a thickness of 10 mm to produce upper fiber layer. Rapidly close the punch 19 of the high-frequency hot press until it touches the upper fiber layer, then increase the pressure to 50 MPa, and at the same time heat at the frequency of 5.5 MHz, the temperature reaches 110° C. after 10 seconds, then keep the said pressure and temperature for 3 min, to produce the bamboo board which is 160 mm thick. Steam the bamboo board to adjust moisture in a drying kiln for 6 hours and then keep it under 40° C. in ventilation environment until the water content is 10 wt %.

### EXAMPLE 3

This example is to illuminate the manufacturing process of a composite bamboo board according to this invention.

Add 980 g phenol-formaldehyde resin, 10 g silane coupling agent KH-590, 2 g OP-10, 5 g starch, and 3 g urea into 2000 mL water, uniformly mix to produce adhesive solution.

Use 1000 mm long moso-bamboo pieces, longitudinally cut it into two pieces and peel off the green and yellow outer covering of the moso-bamboo to make them uniform in color. Then use roller press to grind the moso-bamboo pieces into loose reticulate bamboo fiber bundles whose diameters are 0.001-1 mm, wherein the bamboo fibers not totally detached, therefore to form bamboo fiber bundles connected with others. Dry the bamboo fiber bundles by infrared drying until the water content is 10 wt %, then dip the dried bamboo fiber bundles in the above said adhesive solution for 1 min. Remove and dry to produce bamboo fiber bundles whose adhesive content is 10 wt % and water content is 10 wt %. Transversely spread the produced bamboo fiber bundles whose water content is 10 wt % on the female die insulating plate 24 of the high-frequency hot press as shown in FIG. 1 at a thickness of 20 mm, to produce lower bamboo fiber bundle layer, then longitudinally spread the above said bamboo fiber bundles on top of it at a thickness of 5 mm to produce upper fiber layer. Rapidly close the punch 19 of the high-frequency hot press until it touches the upper fiber layer, then increase the pressure to 25 MPa, and at the same time heat at the frequency of 6.25 MHz, the temperature reaches 135° C. after 10 seconds, then keep the said pressure and temperature for 5 min, to produce the bamboo board which is 25 mm thick. Steam the bamboo board to adjust moisture in a drying kiln for 10 hours and then keep it under 40° C. in ventilation environment until the water content is 10 wt %.

### EXAMPLE 4

This example is to illuminate the manufacturing process of a composite bamboo board according to this invention.

This example is to produce composite bamboo board in the same manner as in Example 3 except that the water content of the bamboo fiber bundles for hot-pressing is 2 wt %. However, as a result, heating for 10 seconds is not enough to increase the temperature of fiber bundle layer to 135° C.; continue to heat and the temperature of fiber bundle layer reaches to 135° C. after 1 hour.

### EXAMPLE 5

This example is to illuminate the manufacturing process of a composite bamboo board according to this invention

This example is to produce composite bamboo board in the same manner as in Example 3 except that the water content of the bamboo fiber bundles for hot-pressing is 20 wt %.

### COMPARATIVE EXAMPLE 1

This example is to illuminate the manufacturing process of a composite bamboo board according to the prior art.

This example is to produce composite bamboo board in the same manner as in Example 3 except that the adhesive is urea-formaldehyde resin solution whose solid content is 20 wt % (pure urea-formaldehyde resin solution).

### COMPARATIVE EXAMPLE 2

This example is to illuminate the manufacturing process of a composite bamboo board according to the prior art.

This example is to produce composite bamboo board in the same manner as in Example 3 except that the hot press is steam hot press, wherein the hot press is carried out with the heating process being convective heating, the pressure being of 30 MPa, the temperature being of 140° C. and the heating time being of 120 min.

### EXAMPLE 6-10

Tests were conducted according to GB/T 17657-1999 and GB/T15780-1995 to examine the strength of bamboo boards prepared in Examples 1-5, and the results are described in the following table 1.

### COMPARATIVE EXAMPLE 3-4

These examples are to illuminate the strength in parallel to grain directon and strength in transverse to grain direction of the bamboo board produced according to the process in the prior art.

Examine the strength of composite bamboo boards prepared in Comparative Examples 3-4 in the same manner as in Examples 6-10.

TABLE 1

| | Example number | | | | | | |
|---|---|---|---|---|---|---|---|
| | | | | | | Co. | Co. |
| | Exam. 6 | Exam. 7 | Exam. 8 | Exam. 9 | Exam. 10 | Exam. 3 | Exam. 4 |
| | Source of bamboo board | | | | | | |
| | | | | | | Co. | Co. |
| | Exam. 1 | Exam. 2 | Exam. 3 | Exam. 4 | Exam. 5 | Exam. 1 | Exam. 2 |
| Tension Parallel to | 150.4 | 151.6 | 162.5 | 140.1 | 142.8 | 90.3 | 70.1 |
| Grain (MPa) | | | | | | | |
| Tension Transverse | 133.9 | 139.2 | 154.0 | 128.5 | 125.8 | 61.2 | 40.3 |
| to Grain (MPa) | | | | | | | |
| MOR Parallel to | 180.0 | 181.5 | 179.5 | 165.0 | 165.6 | 100.8 | 86.4 |
| Grain (MPa) | | | | | | | |
| MOR Transverse to | 178.3 | 179.6 | 169.3 | 165.0 | 165.4 | 70.0 | 44.0 |
| Grain (MPa) | | | | | | | |

As shown in Table 1 above, the composite bamboo board produced according to the process provided by the present invention has equal tension transverse to grain and tension parallel to grain, and the MOR transverse to grain and MOR parallel to grain are also equal; furthermore, all of the data are higher than the similar composite bamboo board produced according to prior art.

1. Manufacturing process of a composite bamboo board, comprising assembling and hot-pressing adhesive-coated bamboo fiber bundles, wherein the said adhesive is a composition comprising of adhesive base material, coupling agent and impregnating wetting agent, the said adhesive base material is one or more selected from a group consisting of urea-formaldehyde resin, melamine, phenolic resin, and water based isocyanate; the said coupling agent is agent which can couple the interfaces of bamboo fiber bundles and the adhesive base material; the impregnating wetting agent is one or more surfactant; and the said hot-pressing includes heating by using high-frequency electromagnetic field with frequency being of 1 KHz or higher and compressing the adhesive-coated bamboo fiber bundles.

2. The process as set forth in claim 1, wherein the said frequency is 1 MHz to 2.5 GHz.

3. The process as set forth in claim 1, wherein the content of the said adhesive base material is 90-99 wt %; the content of the said coupling agent is 0.05-5 wt %; and the content of the said impregnating wetting agent is 0.05-5 wt %, to the total weight of the composition.

4. The process as set forth in claim 1, wherein the said coupling agent is one or more selected from a group consisting of silane coupling agent, titanate coupling agent, and aluminate coupling agent; and the impregnating wetting agent is one or more selected from fatty alcohol-polyoxyethylene ether and nonylphenol ethoxylates.

5. The process as set forth in claim 1, wherein the content of the said adhesive is 3-20 wt % and the content of the said bamboo fiber bundles is 80-97 wt %, to the total dry weight of the said adhesive-coated bamboo fiber bundles.

6. The process as set forth in claim 1, wherein the water content is 6-14 wt % to the said adhesive-coated bamboo fiber bundles which are to be hot-pressed.

7. The process as set forth in claim 1, wherein the pressure of hot-pressing is 10-60 MPa, and the time of hot-pressing is enough to form the bamboo fiber bundles into board shape and solidify the adhesive.
